(19) United States
(12) Patent Application Publication
(10) Pub. No.: US 2007/0084825 A1
(43) Pub. Date: Apr. 19, 2007

(54) Spin-on coater, rotation processing method and color-filter fabricating method

(75) Inventor: Hideaki Yashima, Miyagi (JP)

Correspondence Address: BIRCH STEWART KOLASCH & BIRCH, PO BOX 747, FALLS CHURCH, VA, 22040-0747, US

(73) Assignee: FUJIFILM Corporation

(21) Appl. No.: 11/546,580

(22) Filed: Oct. 12, 2006

(30) Foreign Application Priority Data
Oct. 13, 2005 (JP) P2005-298550

(51) Int. Cl. B08B 3/12; B05C 13/02; C23F 1/00

(52) U.S. Cl. 216/41; 134/1; 118/52

(57) ABSTRACT

A spin-on coater comprises: a turntable that supports thereon and rotates a substrate to be processed; a rotation-drive section that rotatively drives the turntable; and an eccentric slide mechanism that moves a center of the substrate from a center point of rotation up to an eccentric point distant from the center point of rotation, wherein the substrate is rotatively driven so that the center of the substrate is located between the center point of rotation and the eccentric point therefrom.

### BACKGROUND OF THE INVENTION

1. Field of the Invention

The present invention relates to a spin-on coater, rotation-processing method and color-filter fabricating method that applies a thin film to a semiconductor wafer or performs a cleaning of the same.

2. Description of the Related Art

It is a frequent practice to use spin-on coating in the process of precise application to a non-flexible substrate, such as a glass plate, a silicon wafer or an optical disk. The related-art spin-on coater, for use in such a spin-on coating scheme, has a turntable to hold a substrate thereon and rotate it for application, a groove-formed vacuum passage formed in a top surface of the turntable so that the substrate can be vacuum-chucked thereon, a vacuum hole opened through a center of the turntable and communicating with the vacuum passage, a support shaft having axially a vacuum passage and supporting the turntable, an air rotary joint for supplying a vacuum to the vacuum passage and an air tube, a motor coupled to the turntable in a manner rotatively driving it, a cup and top plate arranged around the turntable, and so on.

By putting the substrate on the turntable, operated is a vacuum source such as a vacuum pump connected to the suction-air tube to thereby supply a vacuum to the turntable. The substrate is vacuum-chucked on the turntable by means of the vacuum hole centrally formed through the turntable and of the vacuum passage in the top surface thereof. After applying a constant amount of application liquid (resist) onto the substrate, the substrate is rotated at high rate by the turntable, thereby casting off the unwanted portion of application liquid through the action of a centrifugal force. This enables the application to an even film thickness. (e.g. see JP-A-2005-246228)

Besides forming a resist film, the spin-on coater is also used in cleaning foreign matter off the wafer and casting away unwanted matters through a circular motion about the axis of a wafer center. Such cleaning of foreign matter includes, say, a foreign-matter-cleaning process in color-filter fabrication wherein color-based filter materials (R, G, B) are applied, in order, onto a wafer so that a required region thereof can be left by removing the remaining region by the action of a centrifugal force.

However, in the related-art spin-on coater, the centrifugal force has a magnitude lying in a proportional relationship with the distance of from the rotation axis because the axis is only at the wafer center. As shown in FIG. 12, there occurs a region S where a centrifugal force is insufficiently acted upon, nearby a center P of the wafer W, resulting in an uneven film thickness at between the center and the outer periphery. For this reason, when forming a resist film, the film if desirably applied evenly results in a form raised at the center. In addition, in the on-wafer-foreign-matter cleaning to cast off unwanted matters, a residue occurs nearby the center P of the wafer W. Particularly, where a residue occurs particularly in a color-filter fabrication process, a certain filter color (R) is seeped with another filter color (G).

In this case, there is a reduction in R sensitivity. Because the entire image is corrected during a white-balance adjustment, the occurrence of seepage in a part of filter colors causes a partial wrong color. The occurrence of such seepage of filter color causes a deterioration of color balance on the solid-state imager, resulting in an unacceptable product. Where such a poor filter fabrication is encountered in the cleaning process of foreign matters, a problem develops that the solid-state imager wholly is unacceptable because of the unacceptable color filter despite the integral circuit IC is formed well in quality.

### SUMMARY OF THE INVENTION

The present invention has been made in view of the above situation, and it is an object thereof to provide a spin-on coater, rotation processing method and color-filter fabricating method that can prevent an application film from rising at a center region of the wafer or a residue from occurring, thereby improving the yield in a semiconductor film-forming process.

The object of the invention is to be achieved by the following structure.

(1) A spin-on coater comprises: a turntable that supports thereon and rotates a substrate to be processed; a rotation-drive section that rotatively drives the turntable; and an eccentric slide mechanism that moves a center of the substrate from a center point of rotation up to an eccentric point distant from the center point of rotation, wherein the substrate is rotatively driven so that the center of the substrate is located between the center point of rotation and the eccentric point therefrom.

According to the spin-on coater, the eccentric slide mechanism allows the center of the substrate to move at between the center point of rotation and an eccentric point therefrom. The centrifugal force, acting smaller upon the center of the substrate in the related art in which only the center of the substrate is a center point of rotation, is increased similarly to those of other points.

(2) A spin-on coater according to item (1), wherein the turntable comprises: a first turntable connected to a rotary shaft that rotatively drive the substrate; and a second turntable that holds the substrate and connected to the first turntable through the eccentric slide mechanism.

According to the spin-on coater, when the center of the second turntable is coincident with the center of the first turntable, the center of rotation is placed in coincident with the center of the substrate by rotation of the first turntable. When the eccentric slide mechanism causes the second turntable to move radially of the first turntable, the second turntable, i.e. substrate center, deviates correspondingly from the rotation center of the first turntable. This makes it possible to provide a centrifugal force in a magnitude proportional to the deviation.

(3) A spin-on coater according to item (1) or (2), wherein the second turntable comprises an auxiliary rotation-drive section that rotatively drive the substrate held on the second turntable.

According to the spin-on coater, a centrifugal force is allowed to act upon the substrate center by deviating the substrate center from the rotation center of the turntable, wherein the substrate itself is allowed to rotate. The centrifugal-force increase, at the outer edge of the substrate located radially outward of the turntable, as caused when the substrate is merely deviated at its center radially outward of the turntable, is uniformized to those in other points.

(4) A rotation processing method utilizing a centrifugal force to form a film on a surface of a substrate or clean the surface of the substrate by feeding a liquid onto the substrate being rotatively driven, wherein the substrate is rotatively driven while the center of the substrate is sequentially moved to a plurality of points of between the center point of rotation and an eccentric point distant from the center point of rotation.

According to the rotation processing method, the substrate is rotatively driven sequentially while the center of the substrate being deviated between the center point of rotation and an eccentric point distant from the center point. This allows a centrifugal force to act upon an arbitrary point of the substrate.

(5) A fabricating method for a color filter comprising: a first step of forming a color filter material on a substrate; a second step of forming, by patterning, a resist material over the color filter material; and a third step of performing a cleaning through the resist material patterned as a mask and selectively removing the color filter material; wherein a rotation processing method according to claim 4 is used at least for cleaning the color filter material in the third step.

According to the fabricating method for a color filter, in the process of cleaning by using a patterned resist material as a mask and selectively removing the color-filter material, the silicon substrate is rotatively driven while the center of the substrate is sequentially moved to a plurality of points of between the center point of rotation and an eccentric point distant from the center point of rotation. This allows a centrifugal force to sufficiently act even upon the center of the silicon substrate where a centrifugal force is less acted in the related art, thus eliminating the occurrence of a residue (left resist material) in a center region of the silicon substrate, i.e. the seepage with another color filter material.

### BRIEF DESCRIPTION OF THE DRAWINGS

FIG. 1 is an exploded perspective view of a spin-on coater according to the present invention;

FIG. 2 is a block diagram representing a control system of the spin-on coater shown in FIG. 1;

FIG. 3A is an operation explanatory view of the FIG. 1 spin-on coater in a position before placing the substrate eccentric at its center;

FIG. 3B is an operation explanatory view of the FIG. 1 spin-on coater in a position after placed it eccentric;

FIG. 4 is an explanatory figure typically depicting a centrifugal force that increases as the substrate is put eccentric greater;

FIG. 5 is a plan view of modification 1 using a pin as a substrate hold section;

FIG. 6 is a plan view of modification 2 using a swing arm in an eccentric slide mechanism;

FIG. 7 is a plan view of a second embodiment allowing a substrate on a spin-on coater of the invention to rotate;

FIG. 8 is a typical plan view of a solid-state imager manufactured by a rotation-processing method and color-filter fabricating method according to the invention;

FIG. 9 is a typical sectional view taken on line A-A in FIG. 8;

FIGS. 10A to 10D are figures explaining a film-forming process depicting a procedure to apply a liquid in fabricating a color filter;

FIGS. 11A to 11D are figures explaining a cleaning process depicting a procedure in fabricating the color filter; and

FIG. 12 is a substrate plan view showing a region, where a centrifugal force is insufficient to act, caused on the the related-art device.

### DETAILED DESCRIPTION OF THE INVENTION

With reference to the drawings, explanation will be made in detail below on a preferred embodiment of a spin-on coater, rotation processing method and color-filter fabricating method according to the present invention.

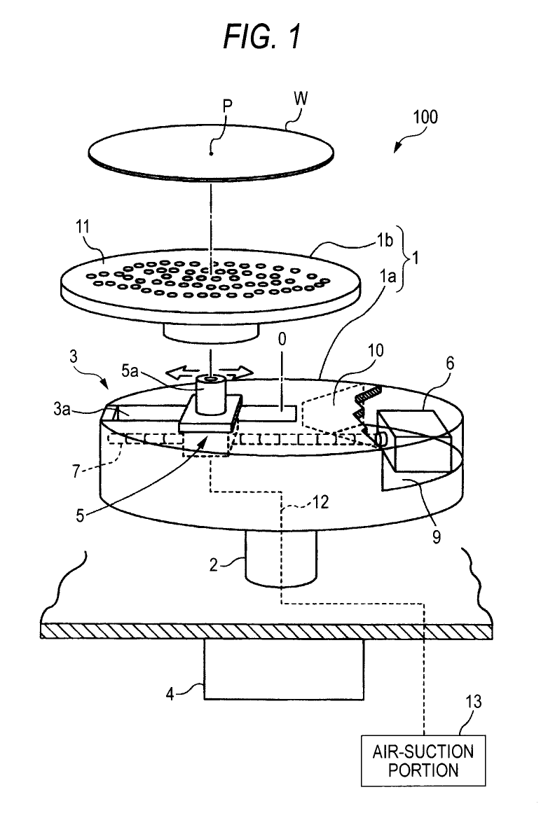

FIG. 1 is an exploded perspective view of a spin-on coater according to the embodiment.

A spin-on coater 100, in this embodiment, has a turntable 1 that rotates, by holding thereon, a substrate (hereinafter, referred to as a “wafer W”) to be processed. The turntable 1 has a first turntable 1a connected on a rotary shaft 2 that rotates the wafer W, and a second turntable 1b connected through an eccentric slide mechanism 3 to the first turntable 1a holding a wafer W thereon.

The rotary shaft 2 of the first turntable 1a is to be rotated by a spin motor 4. Although not shown, a cylindrical spin cup is provided outside of the first turntable 1a. The spin cup has a form/mechanism because of taking account of discharging air during resist application and of splash of the resist. The first turntable 1a has a top surface in which a guide groove 3a is formed straight from a rotation center O toward the radial outward thereof. The guide groove 3a slidably receives a slider 5 supporting a center of the second turntable 1b.

The slider 5 is to be slid by an eccentric drive motor 6 incorporated in the first turntable 1a. Namely, the eccentric drive motor 6 rotatably supports a screw rod 7 extending along the guide groove 3a. The screw rod 7 is coupled to the slider 5 through a ball-screw mechanism. Accordingly, by driving the eccentric drive motor 6, the screw rod 7 is rotated to slide the slider 5 along the guide groove 3a through the ball-screw mechanism. The guide groove 3a, the slider 5, the eccentric drive motor 6 and the screw rod 7 constitute an eccentric slide mechanism. In this embodiment, the second turntable 1b attached on the slider 5 is not rotatable.

The first turntable 1a has a chamber 9, receiving therein the eccentric drive motor 6 and the screw rod 7, on which a cover 10 is mounted. The cover 10 protects the wafer W from being contaminated with dusts.

A plurality of vacuum ports 11 are arranged in the top surface of the second turntable 1b. The vacuum ports 11 are joined together to an integrated air pipe 12. The integrated air pipe 12 is connected to an air-suction portion 13 external of the device through an axle 5a of the slider 5 and the rotary shaft 2. Namely, the wafer W is to be vacuum-chucked on the top surface of the second turntable 1b, under vacuum pressure of from the air-suction portion 13.

In this manner, in the spin-on coater 100, the eccentric slide mechanism 3 is to move the wafer W at its center P from a rotation center O of the first turntable 1a up to an eccentric point distant therefrom. Thus, the wafer W can be rotatively driven about a plurality of points of between the rotation center O and the eccentric point.

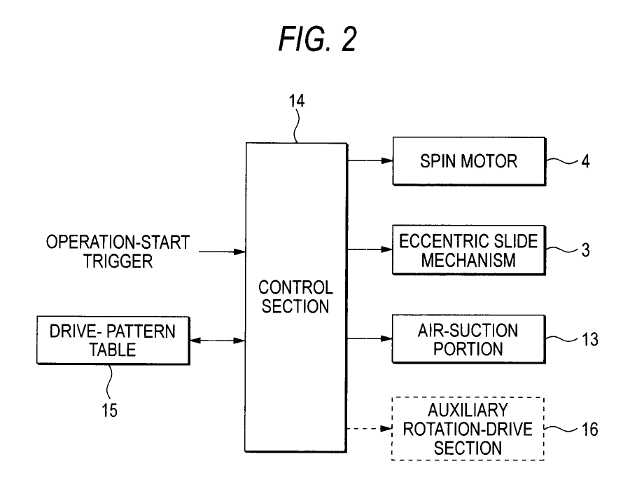

FIG. 2 is a block diagram representing a control system for the spin-on coater shown in FIG. 1.

The spin-on coater 100 has a control section 14 that is connected with the spin motor 4, the eccentric slide mechanism 3, the air-suction portion 13 and the drive-pattern table 15. Incidentally, the control section 14 may be connected with an auxiliary rotation-drive section 16 that is explained in a second embodiment, referred later.

The control section 14 is to operate the air-suction portion 13 according to an operation-start trigger signal inputted, so that the wafer W can be vacuum-chucked on the top surface of the second turntable 1b. Meanwhile, the control section 14 is to rotate the spin motor 4, thereby rotating the first turntable 1a at a predetermined rotational rate. On this occasion, the eccentric slide mechanism 3 places the slider 5 in a non-slidable position wherein the first turntable 1a is coincident at its rotation center O with a center P of the wafer W.

When a resist material is dripped onto the wafer W by a resist drip section, not shown, followed by rotation for a predetermined time, the control section 14 outputs a drive signal to the eccentric slide mechanism 3. The eccentric drive motor 6 of the eccentric slide mechanism 3 is controlled according to a control signal of from the control section 14, to gradually move the slider 5 radially outward of the first turntable 1a. The movement is different depending upon resist material type, rotational rate of the first turntable 1a, size of the wafer W and so on. Those parameters are stored as pre-set control data in the drive pattern table 15. Namely, the control section 14 is adapted to drive-control the spin motor 4 and the eccentric drive motor 6 while reading the control data out of the drive pattern table 15 as to each of resist material type, rotation rate of the first turntable 1a and size of the wafer W.

Explanation is now made on the operation of the spin-on coater constructed as above.

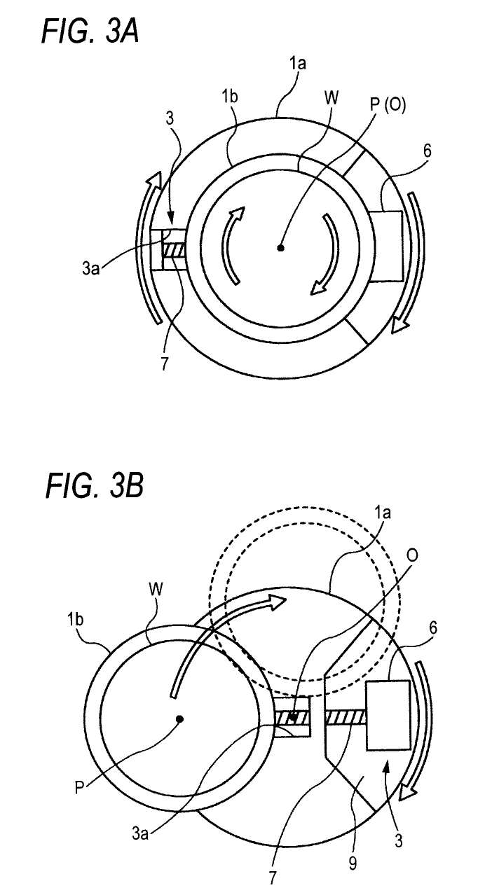

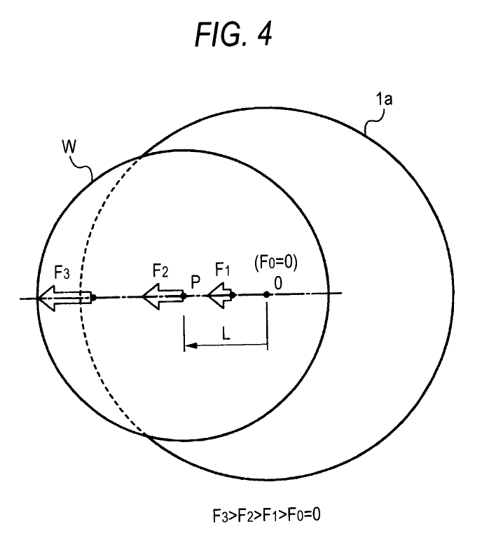

FIG. 3A is an operation explanatory view of the FIG. 1 spin-on coater before placing the substrate eccentric in position at its center. FIG. 3B is an operation explanatory view of the FIG. 1 spin-on coater after placed it eccentric in position. FIG. 4 is an explanatory view typically depicting the centrifugal force that increases as the substrate is placed greater in eccentricity.

In the spin-on coater 100, when the center P of the second turntable 1b is coincident with the rotation center O of the first turntable 1a, the rotation center O and the wafer-W center P are coincident with each other by virtue of rotation of the first turntable 1a, as shown in FIG. 3A.

Meanwhile, as the second turntable 1b is moved radially outward of the first turntable 1a by the eccentric slide mechanism 3 as shown in FIG. 3B, the wafer W at its center deviates from the rotation center 1 of the first turntable la toward the second turntable 1b, i.e. in an amount corresponding to the movement. This results in an increase of centrifugal force F as F0, F1, F2 and F3 (F0<F1<F2<F3) proportionally to the amount of deviation L.

In this manner, the center P of the wafer W is changed in position at between the rotation center O and the deviated point by virtue of the eccentric slide mechanism 3. The centrifugal force F at the wafer-W center P, although acted smaller about a rotation center O taken only at wafer-W center P in the related art, is increased similarly to those of other points.

According to the spin-on coater 100 in this embodiment, the eccentric slide mechanism 3 is provided to move the wafer W at its center P from the rotation center O up to an eccentric point distant so that the wafer W can be rotatively driven about a plurality of points at between the center point P thereof and an eccentric point. A centrifugal force is allowed to act also upon the central region of the wafer W, which can eliminate the difference in magnitude of between the centrifugal forces acting at the wafer-W center P and the periphery thereof.

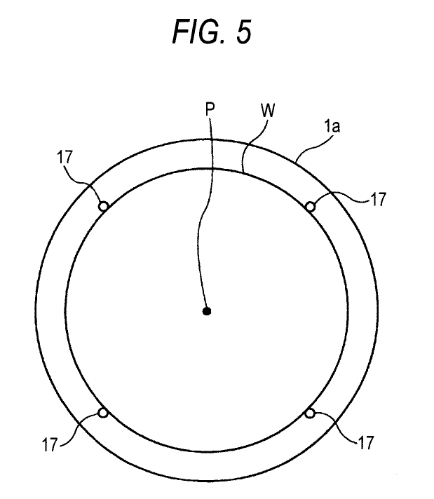

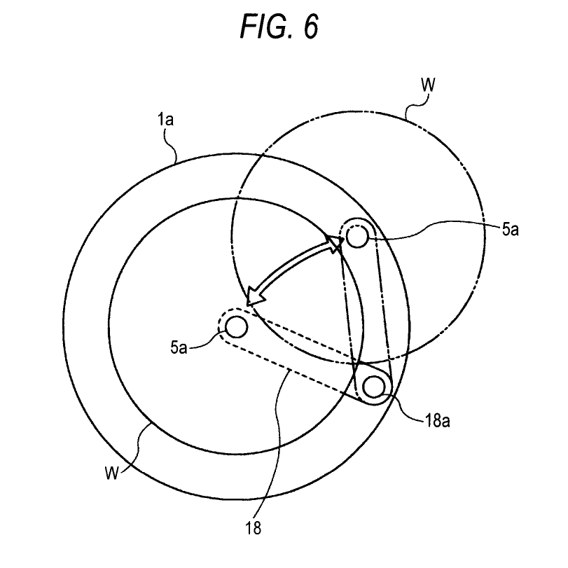

FIG. 5 is a plan view of modification 1 using a pin serving as a substrate hold section while FIG. 6 is a plan view of modification 2 using a swing arm in the eccentric slide mechanism.

Although the foregoing embodiment explained the example the wafer W is vacuum-chucked on the second turntable 1b, the spin-on coater in the invention may be implanted with a pin 17 in the top surface of the first turntable 1a in a manner abutting against the outer periphery of the wafer W and regulating the wafer W from moving radially outward. The provision of such a hold section makes it possible to hold, more positively, the wafer W where a great centrifugal force acts, over the second turntable 1b moving on the first turntable 1a.

Meanwhile, although the foregoing embodiment had the eccentric slide mechanism 3 arranging the screw rod 7, the eccentric drive motor 6, etc. within the first turntable 1a, it may be structured with a swing arm 18 in a peripheral edge of the first turntable 1a through a rotary shaft 18a so that the second turntable 1b can be held at a tip of the swing arm 18. In this case, the swing arm 18 is structured to swingably arrange the second turntable 1b in a non-rotatable state by a not-shown urge section such that the center P of the wafer W coincides with the rotation center O of the first turntable 1a.

With this arrangement, as the first turntable 1a rotates, the second turntable 1b swings due to a centrifugal force in a direction the swing arm 18 rotates clockwise, against the force of the urge section, not shown. This moves the wafer W at its center P in accordance with the rotation rate of the first turntable 1a. The use of such a swing arm 18 simplifies the structure of the eccentric slide mechanism.

Explanation is now made on a second embodiment of a spin-on coater according to the invention.

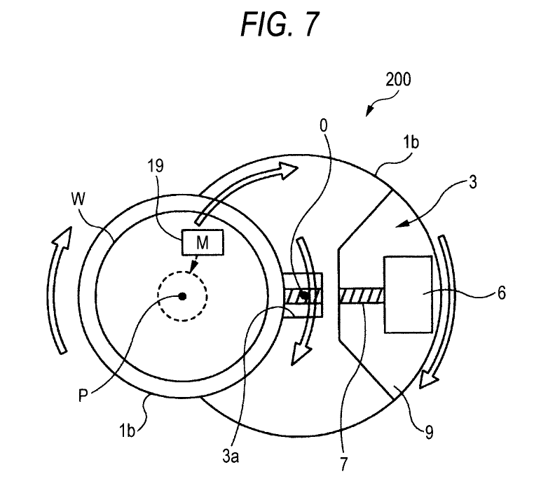

FIG. 7 is a plan view of a spin-on coater, arranged to rotate a substrate, in the second embodiment according to the invention.

In the spin-on coater 200 of the second embodiment, the second turntable 1b has an auxiliary rotation-drive section (motor) 19 to rotatively drive the wafer W held on the second turntable 1b. The auxiliary rotation-drive section 19 is under drive-control of the control section 14. The other structure is similar to the spin-on coater 100.

According to the spin-on coater 200, by deviating the wafer-W center P from the rotation center O of the first turntable 1a, a centrifugal force is acted at the wafer-W center P wherein the wafer W itself is allowed to rotate. This makes uniform the centrifugal-force increase, caused at an outer edge of the wafer W positioned radially outward of the first turntable 1a when the wafer W at its center P is merely deviated radially outward of the first turntable 1a, to those of other regions.

Explanation is now made on a method for fabricating a color filter using the processing-by-rotation method according to the invention.

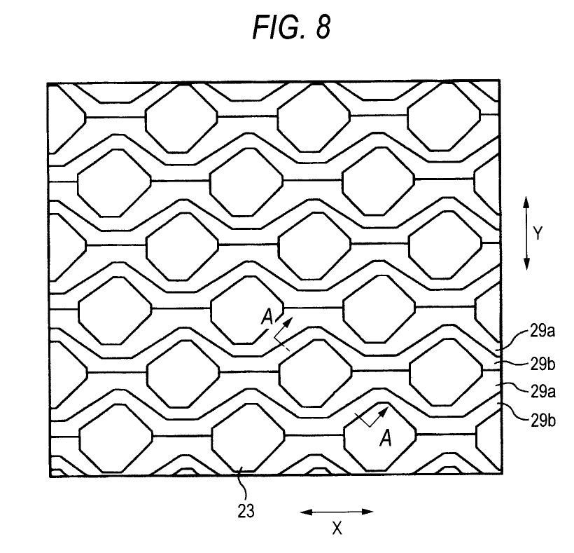

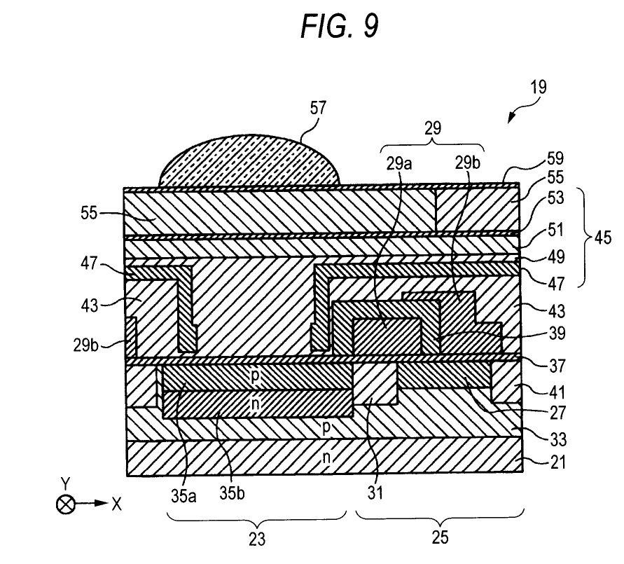

FIG. 8 is a typical plan view of a solid-state imager made by a rotation processing method and color-filter fabricating method according to the invention. FIG. 9 is a typical sectional view taken on line A-A in FIG. 8.

Prior to explaining the method, explanation is first made on a solid-state imager manufactured by the method.

FIGS. 8 and 9 show a solid-state imager 19 that a multiplicity of photodiodes 23, i.e. photoelectric converters, are formed in a surface of an n-type silicon substrate 21. A charge-transfer section 25, for transferring the signal charge generated by the photodiodes 23 in a column direction (in Y-direction in FIG. 9, vertical direction in the page), is formed zigzag between a plurality of photodiode columns each formed by a plurality of photodiode 23 arranged in a column direction.

The charge transfer section 25 includes a plurality of charge transfer channels 27 formed in the column direction over the surface of a silicon substrate 21 respectively correspondingly to the plurality of photodiode columns, charge transfer electrodes 29 (first electrode 29a, second electrode 29b) formed in a layer over the charge transfer channel 27, and charge readout regions 31 through which the charge generated at the photodiode 23 is to be read to the charge transfer channel 27. The charge transfer electrodes 29 extend zigzag wholly in the row direction (in the X-direction in FIG. 9) through between the plurality of photodiode rows each formed by a plurality of photodiodes 23 arranged in the row direction.

A p-well layer 33 is formed in a surface of the silicon substrate 21, to form a p-region 35a in a surface of the p-well layer 33. An n-region 35b is formed immediately beneath the p-region 35a so that the p-region 35a and the n-region 35b constitute a photodiode 23. The signal charge, generated at the photodiode 23, is stored in its n-region 35b.

On the right of the p-region 35a, a charge transfer channel 27 is formed as an n-region spaced a little therefrom. A charge readout region 31 is formed in the p-well layer 33, in a position between the n-region 35b and the charge transfer channel 27.

A gate oxide film 37 is formed on the surface of the silicon substrate 21. First and second electrodes 29a, 29b are formed over the charge readout region 31 and charge transfer channel 27 through the gate oxide film 37. The first and second electrodes 29a, 29b are insulated from each other by an electrode-to-electrode insulation film 39. A channel stop 41 is formed as a p+ region rightward of the vertical transfer channel 27, thus isolating same from the adjacent photodiode 23.

A silicon oxide film 43 is formed over the charge transfer electrode 29, over which an intermediate layer 45 is further formed. Of the intermediate layer 45, reference numeral 47 is a shadow film 47, 49 an insulation film of BPSG (borophospho-silicate glass), 51 an insulation film (passivation film) of P-SIN and 53 planarization layer formed by a transparent resin film. The shadow film 47 is provided by removing an aperture region for the photodiode 23. On the intermediate layer 45, a color filter 55 and a microlens 57 are provided. A planarization layer 59 is provided of a transparent insulating resin between the color filter 55 and the microlens 57.

The imager-device chip 19 is configured to store the signal charge, generated by the photodiode 23, in the n-region 35b, to transfer the signal charge stored therein in the column direction by the charge transfer channel 27, to transfer the transferred signal charge in the row direction by a not-shown charge transfer path (HCCD), and to output through a not-shown amplifier a color signal commensurate with the transferred signal charge.

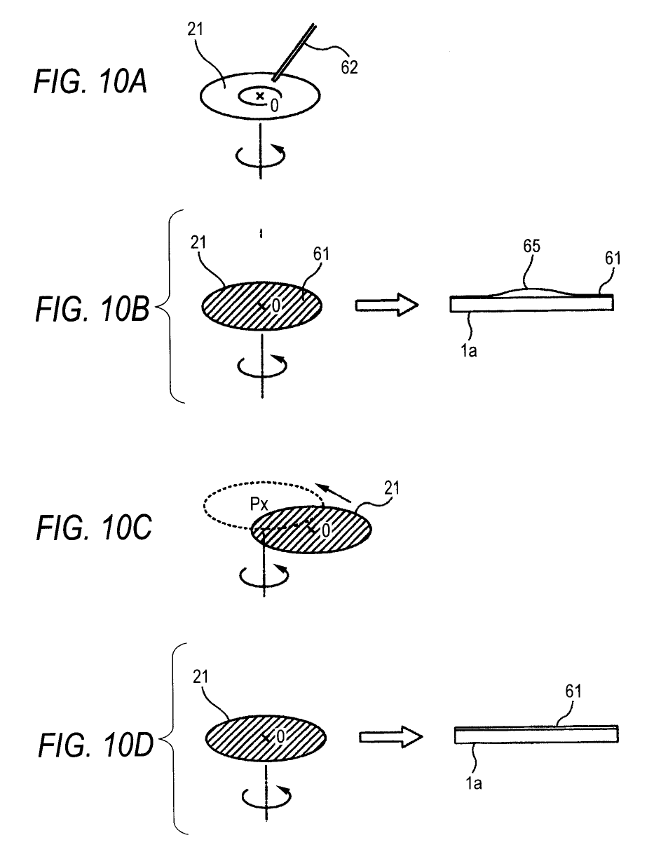

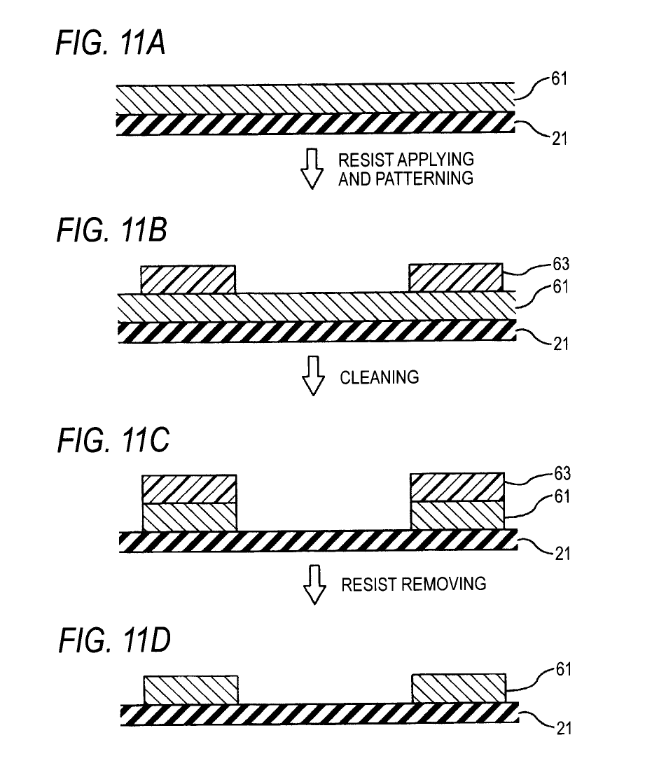

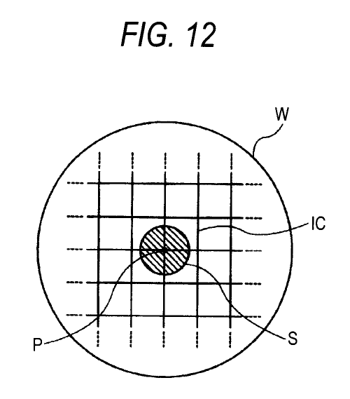

FIGS. 10A to 10D are figures explaining a film-forming process depicting a procedure to apply a liquid in fabricating a color filter. FIGS. 11A to 11D are figures explaining a cleaning process depicting a procedure in fabricating a color filter.

In the fabricating process for a color filter for use in a solid-state imager 19, a color-filter material 61 is formed over a planarization layer 53 overlying the silicon substrate 21, as shown in FIG. 11A. In the illustrated example, a color-filter material 61, e.g. in green (G), is applied.

In the application of a color-filter material 61, a color-filter material 61 is dripped, by a drop section 62, onto a silicon substrate 21 vacuum-chucked on the second turntable 1b of the spin-on coater 100, as shown in FIG. 10A. The color-filter material 61 is planarized by rotation of the first turntable 1a. However, there is a possibility to cause a rise 65, as shown in FIG. 10B, in the vicinity of a rotation center O where a centrifugal force is less acted upon.

After a predetermined time of rotation of the first turntable 1a, the eccentric slide mechanism 3 drives the silicon substrate 21 to move at its center P from the rotation center O of the first turntable 1a to a distant eccentric position as shown in FIG. 10C. This allows the rise portion 65 of color-filter material 61 to move to other regions through the action of a centrifugal force, thus obtaining a planarized film of color-filter material 61 as shown in FIG. 10D. Then, the silicon substrate 21 is put on a hot plate and pre-baked by heating up the G color-filter material 61.

Thereafter, a resist material 63 is applied as shown in FIG. 11B. By photolithography, the G color-filter material 61 is patterned into a predetermined form. Namely, the patterned resist material 63 is used as a mask, to perform a cleaning process for selectively removing the color-filter material 61, as shown in FIG. 11C.

In also the cleaning process step, rotation processing is also implemented to feed a cleaning liquid onto the silicon substrate 21 being rotated and then to rinse the surface of the silicon substrate 21 through the action of a centrifugal force. In the rotation processing method, the silicon substrate 21 is rotatively driven so while the center of the substrate 21 is sequentially moved to a plurality of points of between the center point of rotation and an eccentric point distant from the center point of rotation. Due to this, the silicon substrate 21 is rotatively driven sequentially while being deviated in its rotation center at between the center point of the silicon substrate 21 and an eccentric point distant from that center, thus allowing a centrifugal force to act evenly upon an arbitrary point of the silicon substrate 21.

Similarly, the silicon substrate 21 is rotatively driven while the center P of the silicon substrate 21 is sequentially deviated between the center point of rotation and an eccentric point distant from that center point, thus removing the resist material 63 as shown in FIG. 11D. Due to this, in the process of cleaning by using a patterned resist material 6 as a mask and selectively removing the color-filter material 61, the silicon substrate 21 is rotatively driven while the center P of the silicon substrate 21 is sequentially moved to a plurality of points of between the center point of rotation and an eccentric point distant from the center point of rotation. This allows a centrifugal force to sufficiently act even upon the center p of the silicon substrate 21 where a centrifugal force is less acted in the related art, thus eliminating the occurrence of a residue (left resist material) in the center P of the silicon substrate 21, i.e. the seepage with another color filter material 61.

Then, the silicon substrate 21 is again put on the hot plate, to post-bake the color-filter material 61 by heating it up with the conductive heat from the silicon substrate 21. By fixing the patterned G color-filter material 61, a G color filter is formed.

According to the rotation processing method in this embodiment, the silicon substrate 21 is rotatively driven while the center P of the silicon substrate 21 is sequentially moved to a plurality of points of between the center point of rotation and an eccentric point distant from the center point of rotation. This allows a centrifugal force to act evenly upon an arbitrary point of the silicon substrate 21, thus preventing the film from rising or a residue from occurring in the central region of the silicon substrate 21.

Meanwhile, according to the fabricating method for a color filter in this embodiment, a patterned resist material 63 is used as a mask thereby performing a cleaning to selectively remove the color-filter material 61, in which process the silicon substrate 21 is rotatively driven while the center P of the substrate 21 is sequentially moved to a plurality of points of between the center point of rotation and an eccentric point distant from the center point of rotation. This eliminates a residue from occurring in a central region of the silicon substrate 21 and prevents the seepage with a filter material in the process of cleaning away foreign matters, thus improving the yield of the solid-state imager 19.

According to a spin-on coater of the invention, there is provided an eccentric slide mechanism to move a substrate at its center from a rotation center position thereof up to an eccentric point distant from the rotation center point, to rotatively drive the substrate so that the center of the substrate is located between the center point of rotation and the eccentric point therefrom. This allows a centrifugal force to act even upon the center of the substrate, thus eliminating the difference in magnitude between the centrifugal forces acting upon the center and the periphery thereof.

According to the rotation processing method of the invention, a substrate can be rotatively driven while the center of the substrate is sequentially moved to a plurality of points of between the center point of rotation and an eccentric point distant from the center point of rotation. The centrifugal force is allowed to act evenly upon an arbitrary point on the substrate, which prevents the rise of a film in the central region of the substrate and the occurrence of a residue.

According to a color-filter fabricating method of the invention, a patterned resist material is used as a mask for cleaning to selectively remove the color-filter material, in which process the silicon substrate is rotatively driven while the center of the substrate is sequentially moved to a plurality of points of between the center point of rotation and an eccentric point distant from the center point of rotation. This eliminates a residue from occurring in a central region of the substrate and prevents the seepage with a filter material in the process of cleaning foreign matters, thus improving the yield of the solid-state imager.

The entire disclosure of each and every foreign patent application from which the benefit of foreign priority has been claimed in the present application is incorporated herein by reference, as if fully set forth.

What is claimed is:

1. A spin-on coater comprising:
a turntable that supports thereon and rotates a substrate to be processed;
a rotation-drive section that rotatively drives the turntable; and
an eccentric slide mechanism that moves a center of the substrate from a center point of rotation up to an eccentric point distant from the center point of rotation,
wherein the substrate is rotatively driven so that the center of the substrate is located between the center point of rotation and the eccentric point therefrom.

2. A spin-on coater according to claim 1,
wherein the turntable comprises:
a first turntable connected to a rotary shaft that rotatively drive the substrate; and
a second turntable that holds the substrate and connected to the first turntable through the eccentric slide mechanism.

3. A spin-on coater according to claim 1,
wherein the second turntable comprises an auxiliary rotation-drive section that rotatively drive the substrate held on the second turntable.

4. A rotation processing method utilizing a centrifugal force to form a film on a surface of a substrate or clean the surface of the substrate by feeding a liquid onto the substrate being rotatively driven,
wherein the substrate is rotatively driven while the center of the substrate is sequentially moved to a plurality of points of between the center point of rotation and an eccentric point distant from the center point of rotation.

5. A fabricating method for a color filter, comprising:
a first step of forming a color filter material on a substrate;
a second step of forming, by patterning, a resist material over the color filter material; and
a third step of performing a cleaning through the resist material patterned as a mask and selectively removing the color filter material,
wherein a rotation processing method according to claim 4 is used at least for cleaning the color filter material in the third step.
